(19) United States
(12) Patent Application Publication
(10) Pub. No.: US 2011/0313843 A1
(43) Pub. Date: Dec. 22, 2011

(54) SEARCH ADVERTISEMENT TARGETING

(75) Inventors: Robert L. Rounthwaite, Fall City, WA (US); Mikhail Bilenko, Redmond, WA (US); Matthew Richardson, Seattle, WA (US)

(73) Assignee: Microsoft Corporation, Redmond, WA (US)

(21) Appl. No.: 12/817,259

(22) Filed: Jun. 17, 2010

(51) Int. Cl. G06Q 30/00; G06F 17/30; G06Q 10/00

(52) U.S. Cl. 705/14.42; 705/14.43; 705/14.45; 705/14.54; 707/708; 707/E17.108

(57) ABSTRACT

Described is processing the search results obtained from a search engine to determine advertisements that match properties of those search results. For example, the URL-related information or domain-related information in the search results may be used to select an advertisement. Also described are various conditions that may need to be met before an advertisement is selected. Further, an advertisement may be modified to include information in the search results, such as to insert a competing company's name that appears in a search result into the advertisement. Also described is a system for returning keywords in response to a URL/domain.

### BACKGROUND

When a user sends a query to a search engine, the keywords of the query that express the user's intent are used to find relevant documents, including relevant advertisements. In general, search engine providers make money when a user clicks on an advertisement, and thus search engine providers want to return highly relevant advertisements to increase the chances that an advertisement will be clicked.

Moreover, while advertisers want to reach customers interested in their products, they also want to compete with their competitors. Advertisers currently expend significant resources trying to boost their search rank for keywords that are relevant to them, and on bidding on advertisements for keywords that relate to their products. However, there is no easy way, other than bidding for competitor's brand names, to more directly target a competitor.

The model of having advertisers target advertisements based upon keywords works to an extent because keywords generally tend to express a user's intent. However, advertisers or keyword matching systems are limited in their ability to do so, resulting in occasional irrelevant advertisements. Any improvement in matching the actual intent of users to advertisements, and/or allowing advertisers to target competitors, is beneficial to users, advertisers and search engine providers.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which the search results obtained from a search engine are processed to determine advertisements that match properties of those search results, such as URL-related information or domain related information in the search results. The selected advertisement is provided for inclusion in a search results page (possibly along with one or more other selected advertisements).

In one aspect, selection of the advertisement depends on the search result properties as well as meeting one or more conditions. Example conditions include click data criterion (whether the search result is likely to be clicked), location criterion (where among the search results is the link ranked), and/or frequency criterion (e.g., how often the URL appears). Other conditions such as also having to match a query term, or based upon some threshold number of total query results, may be used as selection criteria.

Search result-selected advertisements may be ranked in the search results page, including among one another, and/or with any other advertisements that may be present, e.g., obtained via keyword searching. Further, an advertisement may be modified based upon the information in the search results, such as to insert a company name that appears in a search result into the advertisement. A selected advertisement may be shown once per query results page, or may be shown for a session or some other time duration.

Also described is a system for returning keywords in response to a URL/domain. In this way, advertisers can obtain the set of keywords that result in the URL/domain being returned in response to a query with the appropriate keywords.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing a search engine that processes search results to find matching advertisements based upon the results.

FIG. 2 is a flow diagram representing example steps that may be taken to process search results for matching advertisements.

FIG. 3 is a block diagram representing mechanisms for returning keywords to an advertiser that match a URL/domain.

FIG. 4 shows an illustrative example of a computing environment into which various aspects of the present invention may be incorporated.

### DETAILED DESCRIPTION

Various aspects of the technology described herein are generally directed towards allowing advertisers to show relevant advertisements based upon properties of the search results returned by the search engine, (rather than only based upon search keywords). For examples, advertisers may target domains or URLs, or URL components that are returned by the search engine, as well as snippets and/or content. By way of example, company X can bid on an advertisement to appear whenever a competitor company Y's domain name is returned in a search result, e.g., “We will beat Company Y's prices! Click to compare.” The canonical or other well-recognized corresponding company name may be mapped from information in the URL.

In general, because the results are provided by a search engine, the user's intent may be discerned with greater accuracy than solely based on keywords provided by advertisers to the keyword matching systems. Allowing the advertiser to target the results that the search engine returns facilitates improved targeting and broader targeting.

While some of the examples herein are directed towards showing advertisements targeting competitors, it should be noted that the technology described herein is directed towards improved matching in general. For example, an advertisement may be relevant/an advertiser want an advertisement displayed whenever someone is navigating to a particular page, such as a photography page on a reference website, or is browsing a particular tourist destination. For example, advertisements for a hotel may be displayed when someone searches for “Snoqualmie Falls”, but not {waterfall on the Snoqualmie River}, although these searches give many of the same search results.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and search technology in general.

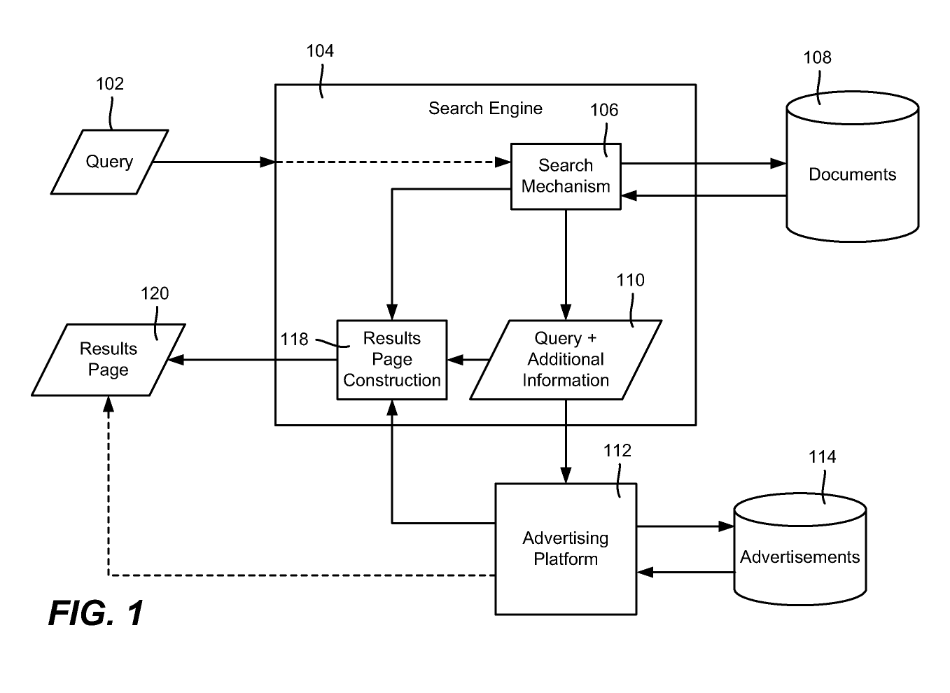

FIG. 1 is a block diagram showing a system for returning advertisements based upon information that appears in the initial search results (e.g., URL/domain). In general, a query 102 is received at a search engine 104. After any pre-processing (the dashed arrow in FIG. 1), a search mechanism 106 of the search engine 104 finds and ranks relevant documents from a set of documents 108, e.g., in a known manner via an index or the like.

As also represented in FIG. 1, the search engine 104 provides the query and additional information 110 (described below) to an advertising platform 112 for obtaining relevant advertisements 114. Note that the search engine may communicate with the advertisement platform via any number of calls, and thus, for example, provide one or more partially-returned results or the full set of results to the advertising platform 112. In this manner, the search engine 104 and advertising platform 112 may perform their respective operations in parallel; e.g., the search engine may compute URL snippets, determine query suggestions, and perform other operations while the advertising platform 112 is finding the relevant advertisement. Thus, the additional information in block 110 of FIG. 1 may be any appropriate data, e.g., whether the query is deemed to be a news query, the set of suggestions, the top ten URLs the search engine will return, the entire results page (minus the advertisements) and so forth.

When the search engine 104 is done with its operations, the search engine 104 obtains the advertisement results from the advertising platform 112, which the search engine 104 may combine (block 118) into a final results page 120 for returning to the user. Note that other alternatives are feasible, e.g., the advertisement platform can modify the results page and send the final results page 120 to the user, and/or the search engine 104 and the advertising platform 112 may independently provide results to the user browser for rendering as a results page.

In this manner, the results page 120 includes links to documents that are conventionally returned in response to the query, possibly along with other information such as images, “Related Searches” and so forth. The search results 120 also may include advertisements based upon keywords, however as described herein, additional advertisements may be returned that are based upon the properties of the search results 120.

More particularly, the advertising platform 112 matches advertisement data to properties of at least some of the results (sent as the additional information) found by the search engine. For example, the results may be processed to extract domain information and other data (e.g., company names) from the links to be returned. As a more particular example, targeting is possible on exact URLs, such as (http://www.xyz123.com/sports/faq.aspx?q=10), query-less URLs such as (http://www.xyz123.com/sports/faq.aspx), URL patterns such as (http://www.xyz123.com/sports/* or http://*.xyz123.com/*.aspx), and/or domains such as (www.xyz123.com or *.xyz123.com). As can be seen, wildcards and the like may be used in matching results to advertisements.

Further, an advertiser may be allowed to specify that more than that pattern matching be considered in determining a match, such as to base advertisement targeting on historical click data and/or the pattern's position in the results. For example, even if a link is returned as a top ten result, it may not be clicked often, which is information that is obtainable via various query-click logs and the like. Further, the lower the ranking of a link, the less likely it will be clicked. Whether or not an advertisement is selected may be based on the likelihood of that link being clicked, which can be determined from historical data and/or its position in the search results.

In addition to processing the links, other direct properties in the search results may be processed, e.g., text snippets accompanying the links may have data extracted therefrom for use in matching search results to an advertisement. Search result properties also may include indirect considerations, such as processing the content of the underlying documents, (which may be done dynamically and/or offline in advance, such as for popular documents and/or results for popular queries).

Beyond properties obtained from text extraction and the like, other properties of the search results may be considered in advertisement matching. For example, whether the query is considered “news”-related (or some other classification) is additional data that may be extracted from the search results on which an advertiser may bid (such as a news magazine company that wants its advertisement displayed whenever a news-related result appears). As another example of a search result property, an advertiser may want an advertisement displayed if less than some threshold number of results is returned, e.g., when two or fewer two documents are found, an advertiser may show an advertisement such as “If you did not find your answer, ask a real person at . . . ” or the like.

The selection of a matching advertisement may be based upon other factors, beyond the results themselves. For example, from the search results, a general area of intent may be determined as a potentially matching property. Advertisement targeting may be based on that general area of intent plus the URLs that the user has recently visited on the search engine, and/or that the user is predicted to visit based on current or recent user behavior, and possibly the behavior of other users. For example, if a user is browsing for tickets to a sporting event in some city, an advertisement for a hotel in that city may be shown even though the returned search results are only related to purchasing tickets. This may be because the intent of seeking tickets is known from historical information to be often preceded by or followed by travel planning.

Advertisers may bid on the location and/or frequency of the URL appearing in the search results, e.g., in at least one of the first three results for the search, or at least twice, and so forth. Advertisers also may bid on “bags” of targets, such as a collection of “car manufacturer domains” for example. Other logical combinations are feasible, such as using query terms in conjunction with post-searching results, e.g., only show an advertisement if a cable television company's domain name appears in a search result and “internet” was a query term, (so that an internet access provider has its advertisements more directed to users who are seeking internet access and not just cable television). Other criterion may include state information such as time-of-day, day-of-week, a combination of these with location, and so forth.

With the properties extracted from the search results, one or more advertisements based on those properties may be selected. These may be added to the results page 120 before returning in response to the query. For example, if the various possible conditions are met, and an extracted company name is considered like a keyword or set of keywords, the advertisements may be selected in a conventional manner, e.g., using bidding-based selection techniques. However alternative selection mechanisms and the like may be used.

As can be seen, the advertisement targeting may fire per query, that is, if the pattern and/or other extracted data are matched for the current query. However, an advertiser also may specify that their advertisement appear as long as the match occurred any time during a current browsing session, or at least up to some minimum time (e.g., for five minutes if the user is still browsing). Note that if space on the results page for showing a previous advertisement or advertisements is limited, some mechanism such as a bidding-based selector may be used to rank and/or determine which previous advertisement or advertisements are shown, and/or in what order.

Thus, advertisements may be triggered directly on the results shown to the user, and/or may be filtered or weighted by the position on the page. Advertisements may be triggered based on historical information about the query and what was clicked. Advertisements may triggered based on these aspects, or instead on a session (e.g., time window or other criteria) basis.

Result-based advertising also may be used internally by the search engine, such as for so-called feature promotions or house ads. For example, a travel site affiliated with a search engine may be promoted when another travel site (e.g., Travelzzz.com) result is displayed.

The appearance of the advertisement (its text, for example) is customizable based on for what domain the advertisement appeared. For example, an advertiser may create an ad with the text: “We guarantee we will beat {domain}'s prices by 10%” which will fire with the appropriate text from the search result inserted as content of the advertisement whenever the search results contain a link for one or more domains (e.g., abcxyz.com or 765uvw.com).

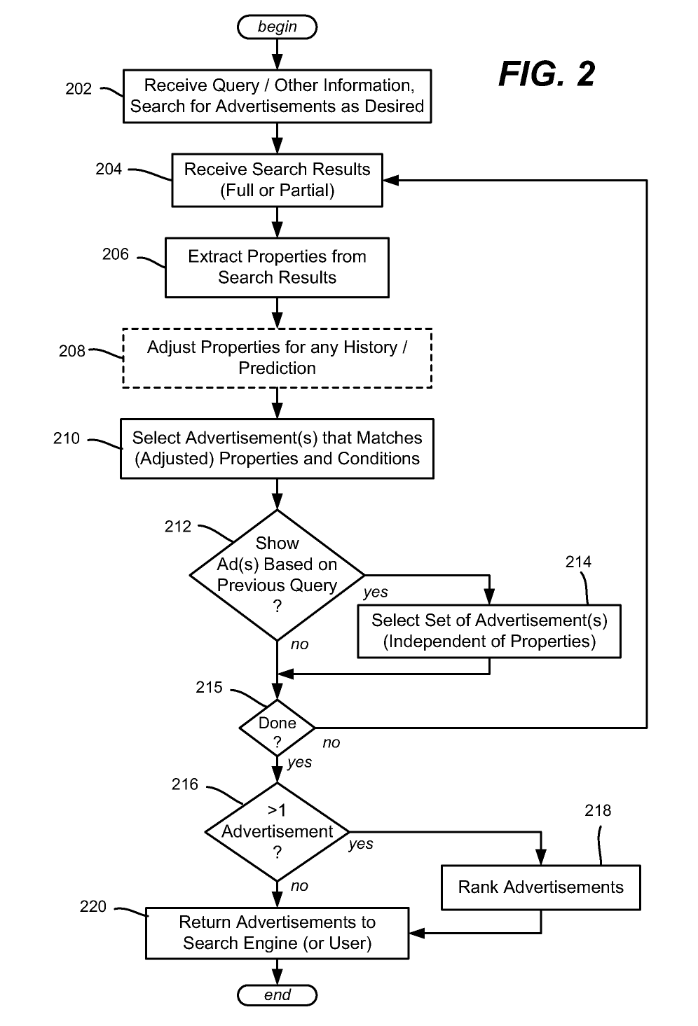

FIG. 2 is a flow diagram that summarizes some of the above aspects from the perspective of the advertising platform 112 in one implementation. At step 202, the query is received from the search engine, possible with various other information as described above. This other information may include the full or partial search results, however this is represented by step 204 to point out that the query and search results may be received in separate calls, e.g., so that the advertising platform may begin finding relevant advertisements based upon the query while it awaits the search results. Step 206 represents extracting the properties from the search results as described above, e.g., directly or indirectly from the results.

Step 208 is an optional step (represented by the dashed block) that may adjust the properties based upon user history or prediction as generally described above. In this manner, for example, an advertisement may be matched to search results even though the results themselves do not exactly match, such as in the above hotel advertisement-for-ticket results example where “hotel” was not a directly returned property but rather was indirectly inferred from the ticket intent plus city information.

Step 210 represents the above-described matching and selection process, where the direct and/or indirect properties and any conditions corresponding to the search results are used as criteria to determine whether any advertisements match. By way of example using some of the above-described criteria, an advertiser may bid on an advertisement being shown when a competitor name appears in a URL, but only if in the top five search results.

As also described above, an advertisement also may appear as a result of session or other timing-related criteria being met, such as to show the advertisement for the remainder of a session regardless of what the user has queried for next, and/or to show an advertisement based upon a previous query (e.g., an advertisement not previously shown because of a low bid, which gets shown later when the user queries for something else). Step 212 represents evaluating whether to show one or more sets of advertisements with the new search results, including any that may be bid based on previous queries. If so, each such advertisement is selected at step 214. As described above, a selection/ranking mechanism may be used if there is insufficient space for showing all such previous advertisements on the current results page.

Step 215 represents determining whether all search results are done being processed, e.g., in an implementation in which partial search results are sent from the search engine to the advertising platform. If not done, the process returns to step 204 to process the next set of partial results (including waiting as needed until the search engine provides them).

Steps 216 and 218 are directed towards ranking the search-result based advertisements when two or more are selected. Note that this may be based on existing technology, e.g., the likelihood of being clicked in conjunction with the amount paid per click and so on. Note that any conventionally selected (by keyword) advertisements may also be considered at this time, e.g., they may be ranked and mixed in with search result-based selected advertisements.

Step 220 represents returning the advertisement or advertisements to the search engine. Note that as described above, depending on the alternative implementation that is used, the advertisement or advertisements may be sent to the user instead, and/or the advertising platform can incorporate the advertisements into the results page before providing the final results page to the search engine or user.

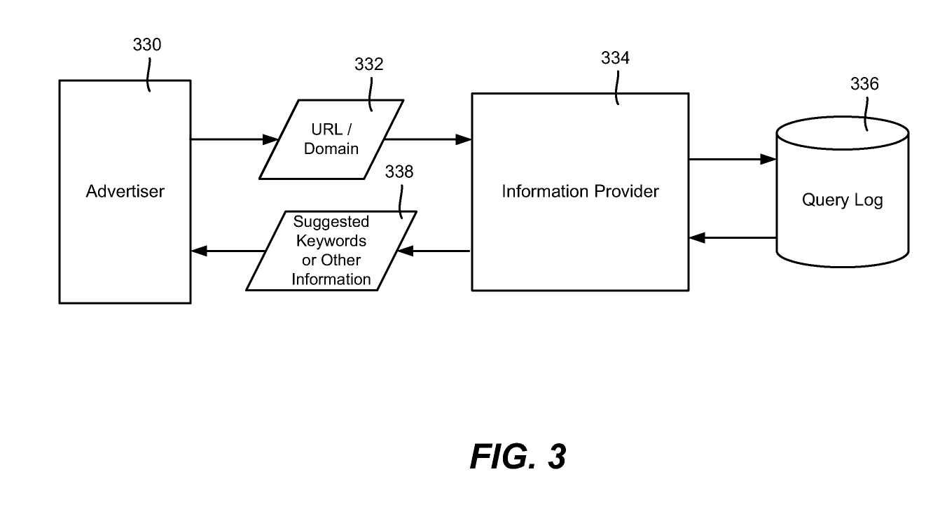

Note that FIGS. 1 and 2 described an implementation that processes the search results, such as a particular URL/domain, to match advertiser bids. However, another implementation shown in FIG. 3 allows advertisers to obtain a set of keywords that approximates this URL/domain, or other information (e.g., queries, as described below).

To this end, FIG. 3 shows a requesting entity (e.g., an advertiser 330) inputting a URL (link) or domain 332 to an information provider 334. For example, the URL may correspond to a competitor, and the advertiser 330 wants to know which keywords have resulted in that competitor's URL being returned. To this end, the information provider 334 processes a query log 336 or the like, e.g., one that maps queries to URLs, in order to determine which keywords, when entered, resulted in that URL being returned. Note that clicks may be considered, e.g., which keywords resulted in a URL being returned that is also clicked some percentage of the time.

The keywords or some subset thereof (e.g., the most frequent of the keywords) that typically lead to that domain or link being displayed are then returned as suggested keywords 338 to the advertiser 330. This facilitates straightforward keyword discovery via a URL or domain, such as that of a competitor.

In this way, the mapping back from the URL or domain entered by an advertiser to a keyword or a set of keywords allows an advertiser to obtain the relevant keywords and thus to target its advertisements more effectively. Note that while this is likely less precise than processing the actual search results obtained for a query, doing so requires less of a change to conventional keyword-based bidding systems, and may incur high computational cost.

Further, note that not only URL/domain bidding may be done in this way. For example, the information provider 334 can “play back” search sessions for some time (e.g., the last X months) to determine for which queries the particular bid condition held. For example, if the advertiser 330 bids for an advertisement to be shown whenever a snippet contains “dog” and the query was a news query, the information provider 334 may process the query log or logs 336, find the searches that match this condition, and return those queries to the advertiser 330.

### Exemplary Operating Environment

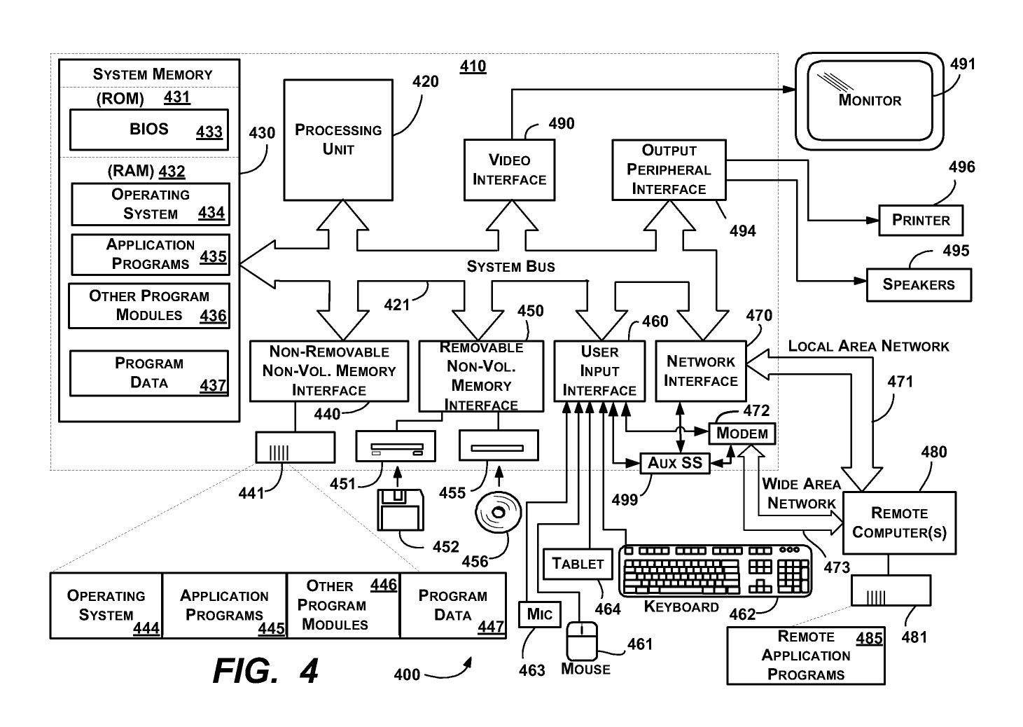

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor comprising:
processing at least part of search results obtained from a search engine for a query to extract one or more search result properties;
selecting an advertisement, including matching an advertisement based upon the one or more search result properties; and
providing the advertisement for inclusion in a search results page that is returned in response to the query.

2. The method of claim 1 wherein selecting the advertisement further comprises meeting one or more conditions.

3. The method of claim 2 wherein meeting the one or more conditions includes meeting at least one click data criterion, meeting at least one location criterion, meeting at least one frequency criterion, meeting at least one query classification criterion, or meeting at least one query term criterion, or any combination of meeting at least one click data criterion, meeting at least one location criterion, meeting at least one frequency criterion, meeting at least one query classification criterion, or meeting at least one query term criterion.

4. The method of claim 1 wherein the search result properties correspond to a URL or a domain, or both a URL and a domain.

5. The method of claim 1 wherein the search result properties correspond to a pattern of a URL.

6. The method of claim 1 wherein the search result properties correspond to a search result snippet or document content, or both a snippet and document content.

7. The method of claim 1 wherein the search result properties are adjusted based upon historical or predicted user behavior, or both historical and predicted user behavior.

8. The method of claim 1 further comprising, ranking the advertisement relative to at least one other advertisement for inclusion in the search results page.

9. The method of claim 1 further comprising, displaying the advertisement in at least one other search result page for a session or for a time.

10. The method of claim 1 further comprising, inserting information from the search results into content of the advertisement.

11. In a computing environment, a system comprising, an information provider that receives data comprising URL-related information, domain-related information or bid condition data from a requesting entity, the information provider accessing historical information to determine a set of keywords or queries that when entered via queries have resulted in a URL or domain or query being returned that corresponds to the URL-related information or domain-related information or bid condition data, the keyword suggestion mechanism returning at least some of the keywords or queries to the requesting entity

12. One or more computer-readable media having computer-executable instructions, which when executed perform steps, comprising:
processing at least part of search results obtained from a search engine to extract URL-related information or domain related information from the search results;
selecting an advertisement based upon the URL-related information or domain related information; and
providing the advertisement for inclusion in a search results page.

13. The one or more computer-readable media of claim 12 having further computer-executable instructions comprising, determining whether to select the advertisement based upon one or more conditions, including at least one click data criterion.

14. The one or more computer-readable media of claim 12 having further computer-executable instructions comprising, determining whether to select the advertisement based upon one or more conditions, including at least one location criterion, or at least one frequency criterion, both at least one location criterion and at least one frequency criterion.

15. The one or more computer-readable media of claim 12 having further computer-executable instructions comprising, determining whether to select the advertisement based upon one or more conditions, including at least one query term criterion, or a threshold number of query results criterion, or both a query term criterion and a threshold number of query results criterion.

16. The one or more computer-readable media of claim 12 wherein providing the advertisement for inclusion in a search results page comprises returning the advertisement to the search engine or to a user who provided the query.

17. The one or more computer-readable media of claim 12 wherein selecting the advertisement comprises determining that the advertisement corresponds to a collection of domains.

18. The one or more computer-readable media of claim 12 further comprising, ranking the advertisement relative to at least one other advertisement.

19. The one or more computer-readable media of claim 12 having further computer-executable instructions comprising, displaying the advertisement in at least one other search result page for a session or for a time.

20. The one or more computer-readable media of claim 12 having further computer-executable instructions comprising, inserting information from the search results as content of the advertisement.
